(19) United States
(12) Patent Application Publication
(10) Pub. No.: US 2012/0117181 A1
(43) Pub. Date: May 10, 2012

(54) SYSTEM FOR AND METHOD OF PROVIDING MOBILE APPLICATIONS MANAGEMENT

(75) Inventors: Kanti S. PATEL, Hiawatha, IA (US); Guna D. GUNASEKAR, Cedar Rapids, IA (US); James M. McGUIRE, Raleigh, NC (US); John F. LAMBERT, Apex, NC (US)

(73) Assignee: VERIZON PATENT AND LICENSING, INC., Basking Ridge, NJ (US)

(21) Appl. No.: 12/940,482

(22) Filed: Nov. 5, 2010

(51) Int. Cl. G06F 15/16

(52) U.S. Cl. 709/217

(57) ABSTRACT

A system for and method of providing mobile device management. The system and method may include identifying, to a customer, a mobile management system that is communicatively coupled to a customer system associated with the customer via a first network and communicatively coupled to a plurality of mobile devices associated with the customer via a second network, storing, on the mobile management system, a plurality of template mobile applications, receiving, from the customer system, modification data associated with one of the plurality of template mobile applications via the first network, modifying the one of the plurality of template mobile applications based on the modification data, and transmitting, to the plurality of mobile devices, the modified one of the plurality of template mobile applications via the second network.

### BACKGROUND INFORMATION

In general, mobile devices are increasingly being used to maintain access to information and communication networks. In many instances, employees of business organizations (e.g., large multinational companies) use mobile devices to maintain access to company systems and complete daily tasks. Such business organizations may spend a substantial amount of time and resources managing the mobile devices with enterprise applications (e.g., acquiring the mobile devices, provisioning the mobile devices, configuring the mobile device).

### BRIEF DESCRIPTION OF THE DRAWINGS

The present invention, together with further objects and advantages, may best be understood by reference to the following description taken in conjunction with the accompanying drawings, in the several figures of which like reference numerals identify like elements, and in which:

FIG. 1 is a schematic diagram illustrating a mobile device management system according to a particular embodiment;

FIG. 2 is a schematic diagram of components of an application enablement module of a mobile management system according to a particular embodiment;

FIG. 3 is an exemplary order, setup, billing, and development work flow according to a particular embodiment;

FIG. 4 is an exemplary provisioning work flow according to a particular embodiment;

FIG. 5 is an exemplary deployment work flow according to a particular embodiment;

FIG. 6 is a schematic diagram of application enablement platform offerings according to a particular embodiment;

FIG. 7 is a schematic diagram of a platform instance architecture according to a particular embodiment; and

FIG. 8 is a flowchart illustrating the functionality of a particular embodiment.

### DETAILED DESCRIPTION OF PREFERRED EMBODIMENTS

As the use of mobile devices increases, so too does the need to integrate such mobile devices (e.g., mobile phones, personal digital assistants, electronic readers, smart phones) into an information system infrastructure. Integrating and managing multiple mobile devices, however, may present several challenges. Such challenges include any, or a combination, of managing multiple fixed and mobile operator contracts, selecting mobile devices, ensuring interoperability between networks, applications, and mobile devices, protecting data, and maintaining manageable communication costs.

As a solution to these mobile management challenges, a mobile device management system manages mobile devices on behalf of customers (e.g., large multinational corporations) that have subscribed to a mobile management service. The mobile management service may provide customers with an integrated family of software tools configured to aid the customers in managing the deployment, expenses, and support of mobile devices. In certain embodiments, the mobile management service provides any, or a combination, of inventory and expense management tools, logistics tools, mobile device management tools, mobile device security tools, mobile applications management tools, and mobile services enablement tools. Customers may subscribe to (or contract for) the software tools individually or in combination.

The mobile services enablement tools may provide a flexible way for customers to design, develop, and manage mobile applications for mobile devices. In one embodiment, the mobile applications may be configured to be compatible with many different mobile environments (e.g., different mobile device types, different countries). In another embodiment, the mobile applications may be configured to be compatible with many different mobile device carriers (e.g., Verizon wireless, AT&T wireless).

The mobile services enablement tools may support the development, deployment, and management of common customer applications. The mobile services enablement tools may also support mobile applications that are developed using customizable templates (e.g., template mobile applications) that are stored on the mobile device management system. A customizable template may allow a customer to develop a generic mobile application that can be executed by multiple mobile devices of varying mobile device types (e.g., Apple's iPhone, Research in Motion's Blackberry) and varying mobile device carriers (e.g., Verizon wireless, AT&T wireless). In such embodiments, the mobile services enablement tools may use the generic mobile application developed by the customer to create multiple device-specific mobile applications.

The mobile management service may provide customers with the following mobile application management features. The mobile management service may store mobile applications on a mobile device management system (e.g., a mobile device management server). In another example, the mobile management service may deploy (e.g., push, transmit) mobile applications to mobile devices. In another example, the mobile management service may provide mobile devices with access to data stored on a customer system (e.g., a backend server) via the mobile device management system. In another example, the mobile management service may provide data synchronization between any, or a combination, of the mobile device management system, the mobile devices, and the customer system. In yet another example, the mobile management service may provide data profile management. In yet another example, the mobile management service may provide platform support (e.g., tools support). In yet another example, the mobile management service may provide helpdesk support.

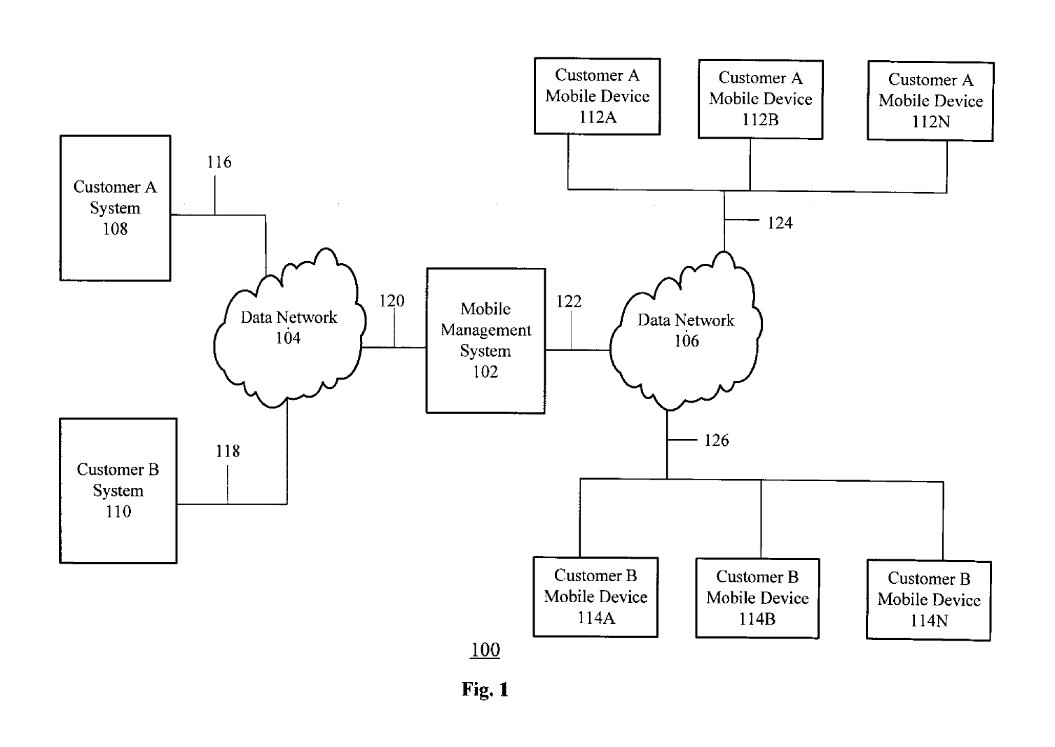

FIG. 1 is a schematic diagram illustrating a mobile device management system according to a particular embodiment. A mobile device management system 100 may communicatively couple together any, or a combination, of customer A system 108, customer B system 110, mobile management system 102, customer A mobile devices 112A, 112B, 112N, and customer B mobile devices 114A, 114B, 114N, using any, or a combination, of data networks 104, 106 and data paths 116, 118, 120, 122, 124, 126. Accordingly, data signals may be transmitted to any of the components of the mobile device management system 100 and transmitted from any of the components of the mobile device management system 100 using any, or a combination, of data networks 104, 106 and data paths 116, 118, 120, 122, 124, 126. For example, order/setup data signals, mobile application development data signals, provisioning data signals, mobile application deployment data signals, or any other data signals may be transmitted to any of the components of the mobile device management system 100 and transmitted from any of the components of the mobile device management system 100 using any, or a combination, of data networks 104, 106 and data paths 116, 118, 120, 122, 124, 126.

Data networks 104, 106 may be a wireless network, a wired network, or any combination of wireless network and wired network. For example, data networks 104, 106 may include one or more of a fiber optics network, a passive optical network, a cable network, an Internet network, a public network, a private network, a satellite network (e.g., operating in Band C, Band Ku, or Band Ka), a wireless local area network (LAN), a Global System for Mobile Communication (GSM), a Personal Communication Service (PCS), a Personal Area Network (PAN), D-AMPS, Wi-Fi, Fixed Wireless Data, IEEE 802.11a, 802.11b, 802.15.1, 802.11n and 802.11g or any other wired or wireless network for transmitting and/or receiving a data signal. In addition, data networks 104, 106 may include, without limitation, a telephone line, fiber optics, IEEE Ethernet 802.3, a wide area network (WAN), a LAN, or a global network, such as the Internet. Also, data networks 104, 106 may support, an Internet network, a wireless communication network, a cellular network, or the like, or any combination thereof. Data networks 104, 106 may further include one, or any number of the exemplary types of networks mentioned above operating as a stand-alone network or in cooperation with each other. Data networks 104, 106 may utilize one or more protocols of one or more network elements to which it is communicatively coupled. Data networks 104, 106 may translate to or from other protocols to one or more protocols of network devices. Although data networks 104, 106 is depicted as one network, it should be appreciated that according to one or more embodiments, data networks 104, 106 may comprise a plurality of interconnected networks, such as, for example, a service provider network, the Internet, a broadcaster's network, a cable television network, corporate networks, and home networks.

Customer A system 108, customer B system 110, mobile management system 102, customer A mobile devices 112A, 112B, 112N, and customer B systems 114A, 114B, 114N may transmit data to and receive data from data networks 104, 106 representing order/setup data, mobile application development data, provisioning data, mobile application deployment data, and other data. The data may be transmitted and received utilizing a standard telecommunications protocol or a standard networking protocol. For example, one embodiment may utilize Session Initiation Protocol (SIP). In other embodiments, the data may be transmitted, received, or a combination of both, utilizing other VoIP or messaging protocols. For example, data may also be transmitted, received, or a combination of both, using Wireless Application Protocol (WAP), Multimedia Messaging Service (MMS), Enhanced Messaging Service (EMS), Short Message Service (SMS), Global System for Mobile Communications (GSM) based systems, Code Division Multiple Access (CDMA) based systems, Transmission Control Protocol/Internet (TCP/IP) Protocols, or other protocols and systems suitable for transmitting and receiving data. Data may be transmitted and received wirelessly or may utilize cabled network or telecom connections such as: an Ethernet RJ45/Category 5 Ethernet connection, a fiber connection, a traditional phone wire-line connection, a cable connection, or other wired network connection. Data networks 104, 106 may use standard wireless protocols including IEEE 802.11a, 802.11b and 802.11g. Data networks 104, 106 may also use protocols for a wired connection, such as an IEEE Ethernet 802.3.

Customer A mobile devices 112A, 112B, 112N and customer B mobile devices 114A, 114B, 114N may be communicatively coupled to data network 106 via data paths 124, 126, respectively. The customer A mobile devices 112A, 112B, 112N and customer B mobile devices 114A, 114B, 114N may include, but are not limited to, computer devices or communications devices including, e.g., a personal digital assistant (PDA), a cellular phone, a smart phone, an electronic reader device, a handheld device, a netbook, a handheld PC, a personal navigation device (PND), or any other device that is configured to receive mobile application deployment data and access corresponding customer system (e.g., customer A system 108, customer B system 110) via the mobile management system 102.

Customer A system 108 and customer B system 110 may be communicatively coupled to data network 104 via data paths 116, 118, respectively. The customer A system 108 and customer B system 110 may include, but are not limited to, a computer device or communications device including, e.g., a personal computer (PC), a workstation, a mobile device, a thin system, a fat system, a network appliance, an Internet browser, a server, a lap top device, a VoIP device, an ATA, a video server, a Public Switched Telephone Network (PSTN) gateway, a Mobile Switching Center (MSC) gateway, or any other device that is configured to store data, receive and transmit order/setup data signals, receive and transmit mobile application development data, and receive and transmit provisioning data signals.

Mobile management system 102 may be communicatively coupled to data network 104 via data path 120 and data network 106 via data path 122. The mobile management system 102 may include, but is not limited to, a computer device or communications device including, e.g., a personal computer (PC), a workstation, a mobile device, a thin system, a fat system, a network appliance, an Internet browser, a server, a lap top device, a VoIP device, an ATA, a video server, a Public Switched Telephone Network (PSTN) gateway, a Mobile Switching Center (MSC) gateway, or any other device that is configured to provide a mobile management service, initiate an order and set-up process for a subscribing customer, provision new mobile devices, develop and create mobile applications, deploy mobile applications to mobile devices, synchronize data, provide access to customer systems (e.g., customer A system 108, customer B system 110), and host (e.g., store) mobile applications. Details of the mobile management system 102 are provided below.

Data paths disclosed herein may include any device that communicatively couples one or more devices to each other. For example, data paths may include one or more networks (e.g., a wireless network, a LAN) or one or more conductive wires (e.g., copper wires).

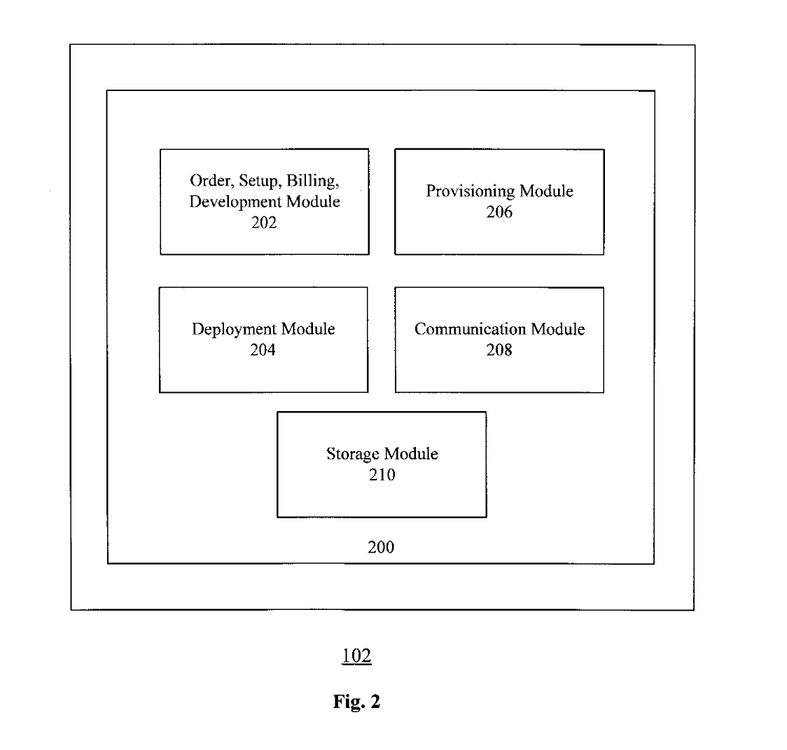

FIG. 2 is a schematic diagram of components of an application enablement module of a mobile management system according to a particular embodiment. The mobile management system 102 may include an application enablement module 200. The application enablement module 200 may include an order, setup, billing, and development module 202, a provisioning module 206, a deployment module 204, a communication module 208, and a storage module 210. It is noted that the modules 200, 202, 204, 206, 208, and 210 are exemplary. The functions of the modules 200, 202, 204, 206, 208, and 210, may be performed at other modules remote or local to the mobile management system 102, and the modules 200, 202, 204, 206, 208, and 210 may be combined or separated.

The communication module 208 may include computer-implemented software, hardware, or a combination of both, configured to provide communication between the mobile management system 102 and the customer systems (e.g., customer A system 108, customer B system 110) via data path 120 and between the mobile management system 102 and the customer mobile devices (e.g., customer A mobile devices 112A, 112B, 112N, customer B mobile devices 114A, 114B, 114N) via data path 122. In one embodiment, the communication module 208 may be configured to receive or transmit data signals to and from one or more components of the mobile device management system 100. In another embodiment, the communication module 208 may be configured to transmit the data signals or messages received from other components in the mobile device management system 100 to the other modules 200, 202, 204, 206, and 210 and may communicate data signals or messages received from the other modules 200, 202, 204, 206, and 210 to other components in the mobile device management system 100. The communication module 208 may be configured to transmit data signals and messages between the modules 200, 202, 204, 206, and 210 of the mobile management system 102.

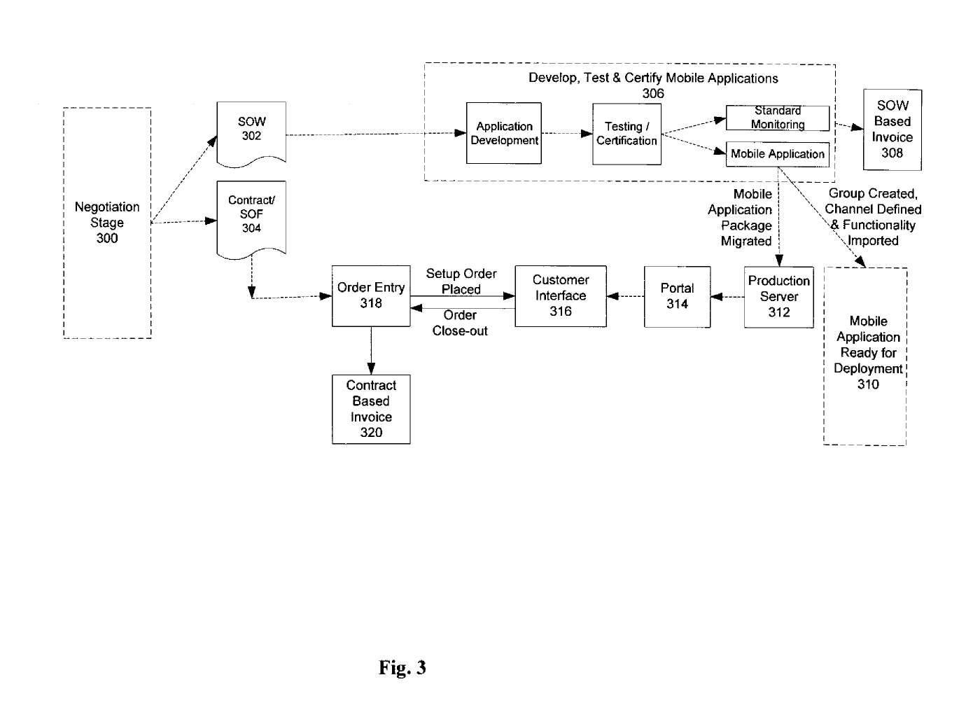

The order, setup, billing, and development module 202 may include computer-implemented software, hardware, or a combination of both, configured to implement or execute an order, setup, and development work flow. Exemplary functions of the order, setup, billing, and development module 202 are described in further detail with reference to FIG. 3.

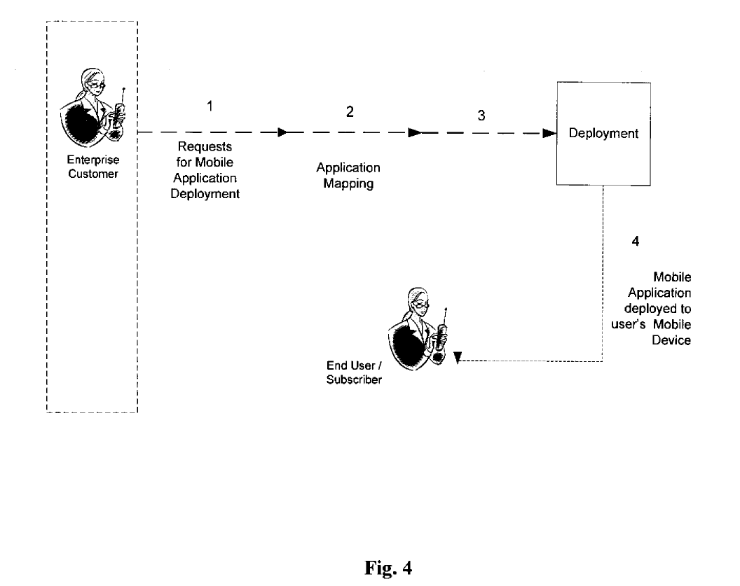

The provisioning module 206 may include computer-implemented software, hardware, or a combination of both, configured to implement or execute a provisioning work flow. Exemplary functions of the provisioning module 206 are described in further detail with reference to FIG. 4.

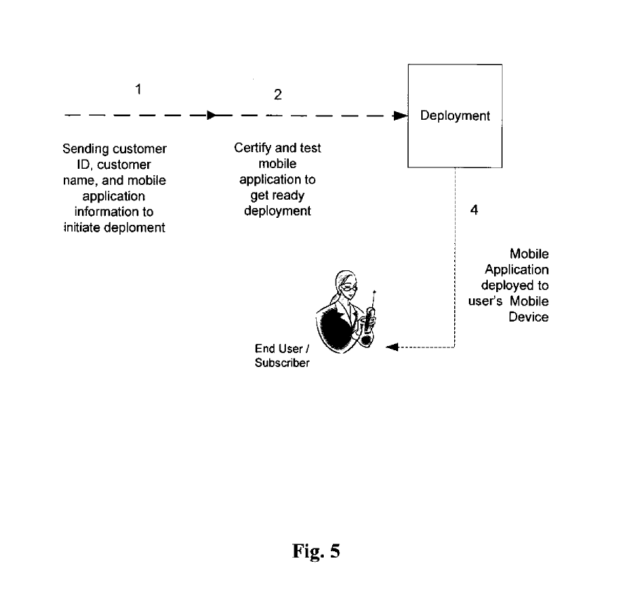

The deployment module 204 may include computer-implemented software, hardware, or a combination of both, configured to implement or execute a deployment work flow. Exemplary functions of the deployment module 204 are described in further detail with reference to FIG. 5.

The storage module 210 may include computer-implemented software, hardware, or a combination of both, configured to store data. In one embodiment, the storage module 210 may be configured to store mobile applications. For example, the storage module 210 may include a database configured to store any, or a combination, of template mobile applications and generic mobile applications. In another embodiment, the storage module 210 may be configured to store order/setup data, mobile application development data, provisioning data, mobile application deployment data, or any other data.

FIG. 3 is an exemplary order, setup, billing, and development work flow according to a particular embodiment. As illustrated in FIG. 3, an order, setup, billing, and development work flow may be initiated at a negotiation stage 300 between a representative (e.g., sales representative) of the implementers of the mobile management system 102 and a customer. Based on the outcome of the negotiation stage, a statement of work (SOW) 302 may be created and executed for the development of one or more mobile applications and a contract 304 may be created and executed for the setup and deployment of the developed mobile applications. An order 318 may be entered into the mobile management system 102 that reflects the executed contract between the representative and the customer.

In certain embodiments, mobile applications for the customer's mobile devices may be designed and developed during a develop, test, and certification stage 306. A generic mobile application may be developed using one or more template mobile applications that are stored on the mobile management system 102. The customer (or the implementer of the mobile management system 102) may modify (e.g., customize) the one or more template mobile applications based on design preferences. Once modified, the generic mobile application may be tested (e.g., debugged) and certified. The generic mobile application may then be considered ready for deployment (e.g. transmission) to the mobile devices at a deployment stage 310.

In one embodiment, the generic mobile application may be compatible with any mobile device type. For example, the generic mobile application may be compatible with any type of mobile phone (e.g., Apple's iPhone, Research in Motion's Blackberry), any type of electronic reader (e.g., Amazon's Kindle, Apple's iPad), and any type of PDA. In another embodiment, the generic mobile application may be compatible with any mobile carrier type. For example, the generic mobile application may be compatible any wireless network (and wireless carrier).

The order, setup, billing, and development work flow may also provide the generic mobile application to a server 312 that allows the mobile devices to subscribe to receive the generic mobile application. The order, setup, billing, and development work flow may then close out the order that was created.

FIG. 4 is an exemplary provisioning work flow according to a particular embodiment. As illustrated in FIG. 4, a provisioning work flow may be initiated by the customer requesting subscription to the mobile management service by providing a list of mobile devices operated by the employees of the customer.

For example, the customer may provide a list of mobile devices to receive a particular generic mobile application. Based on the list of mobile devices provided, the provisioning work flow may update the mapping of a generic mobile application to the mobile devices provided in the list. The provisioning work flow may then pass the request for deployment of the generic mobile application to the mobile devices provided in the list. Prior to deployment, for each mobile device to which the generic mobile application is to be deployed, the generic mobile application may be configured to be a device-specific application that corresponds to the mobile device to which the mobile application is deployed.

In certain embodiments, the generic mobile application may be configured to be a device-specific application by modifying the generic mobile application to be compatible with any, or a combination, of an operating system operating on a particular mobile device, a carrier on which a particular mobile device operates, and communication standards associated with the country in which the mobile device operates. Accordingly, the customer creates a single generic mobile application that is compatible with many of the customer's mobile devices.

FIG. 5 is an exemplary deployment work flow according to a particular embodiment. As illustrated in FIG. 5, a deployment work flow may be initiated by sending a customer identification number, a client name, and mobile application information to a deployment portal. Once tested and certified, the mobile application is deployed to the appropriate mobile device. The mobile device receiving the mobile application is provided with connectivity to the corresponding customer system through the mobile management system 102 for data synchronization.

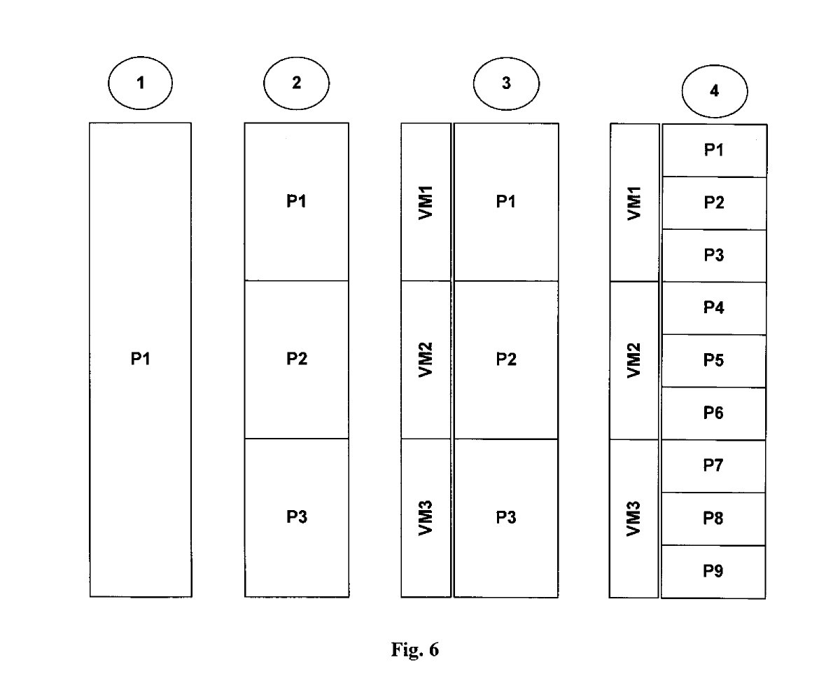

FIG. 6 is a schematic diagram of application enablement platform offerings according to a particular embodiment. As illustrated in FIG. 6, the mobile management service may be provided in different hosting configurations and on different platform configurations based on the type of deployment. In one embodiment, the hosting configuration and platform configuration may be as depicted in option 1. Option 1 may include a single server and a single platform instance. In another embodiment, the hosting configuration and platform configuration may be as depicted in option 2. Option 2 may include a single server and multiple platform instances. In another embodiment, the hosting configuration and platform configuration may be as depicted in option 3. Option 3 may include a single server, multiple virtual machines, and a single platform instance per virtual machine. In another embodiment, the hosting configuration and platform configuration may be as depicted in option 4. Option 4 may include a single server, multiple virtual machines, and multiple platform instances per virtual machine.

The standard mobile management service (e.g., basic mobile management service) may include the multi-tenant hosting configurations (e.g., option 3, option 4). That is, multiple mobile devices of multiple customers of the implementers of the mobile management system 102 may share a single server (e.g., platform infrastructure) to access data from corresponding customer systems. Each customer may be associated with a distinct virtual machine such that each customer is isolated from other customers.

The premium mobile management service (e.g., enhanced mobile management service) may include the single-tenant hosting configuration (e.g., option 1). That is, multiple mobile devices of a single customer of the implementers of the mobile management system 102 may access a single server (e.g., platform infrastructure) to access data from the corresponding customer system.

The mobile management service may also provide mobile business continuity plans for each hosted platform. Such mobile business continuity plans may include a high availability plan and a disaster recovery plan. In one embodiment, a mobile business continuity plan may include an assessment of a mobile application architecture for high availability and fail over continuity. In another embodiment, a mobile business continuity plan may include recommended implementations for any, or a combination, of mobile applications, networks, and architectures to ensure mobile application availability.

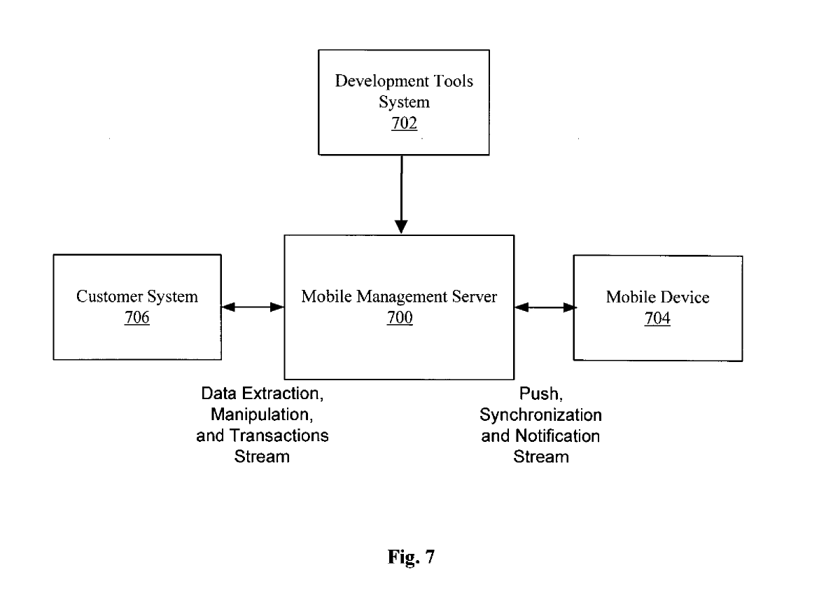

FIG. 7 is a schematic diagram of a platform instance architecture according to a particular embodiment. The architecture of a platform instance as described in FIG. 6 may be as depicted in FIG. 7. A mobile management server 700 may include a tooling application programming interface (API) that is communicatively coupled to a development tools system 702 for developing mobile applications. The mobile management server 700 may also include caching features, security features, personalization features, notification features, and provisioning features. The mobile management server 700 may be communicatively coupled to a data services layer that is configured to access data from one or more sources (e.g., customer database, customer web services, customer files, customer system), such as data stored on customer system 706. The mobile management server 700 may also be communicatively coupled to a synchronization layer that is configured to synchronize data between mobile devices (e.g., mobile device 704) and the mobile management server 700.

The mobile devices (e.g., mobile device 704) may include API features, data persistence features, notification features, and device management and security features. The data persistence features may be operated through a data persistence module communicatively coupled to the mobile devices (e.g., mobile device 704). The notification features may be operated through a notification mobile communicatively coupled to the mobile devices (e.g., mobile device 704). The device management and security features may be operated through a device management and security module communicatively coupled to the mobile devices (e.g., mobile device 704).

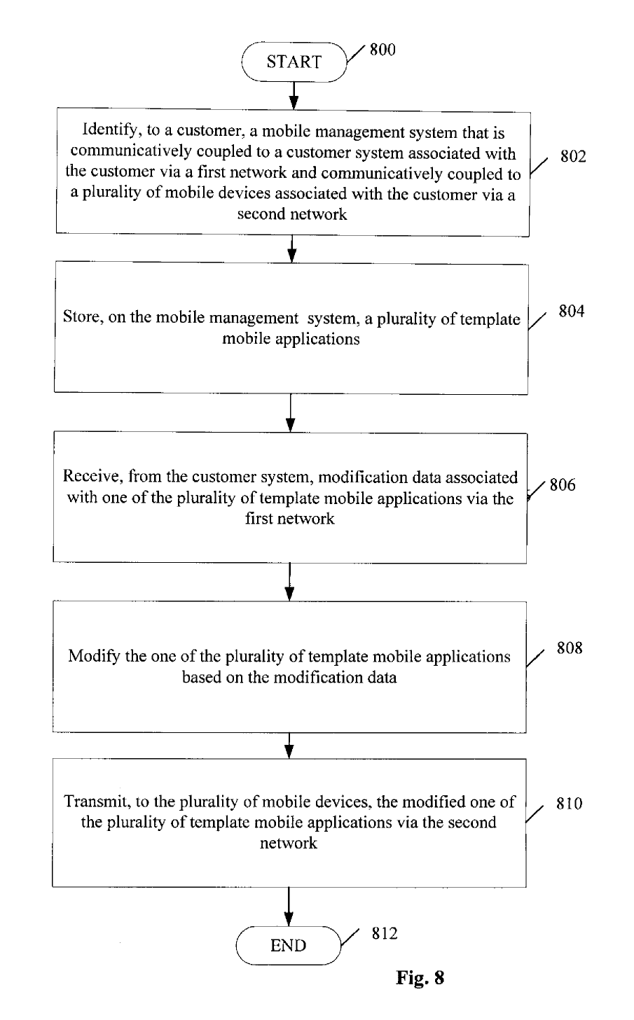

FIG. 8 is a flowchart illustrating the functionality of a particular embodiment. This exemplary method is provided by way of example, as there are a variety of ways to carry out methods disclosed herein. The method shown in FIG. 8 may be executed or otherwise performed by one or a combination of various systems. The method is described below as carried out by the mobile management system 102 shown in FIG. 1 by way of example, and various elements of the mobile management system 102 are referenced in explaining the example method. Each block shown in FIG. 8 represents one or more processes, methods, or subroutines carried out in the exemplary method. Referring to FIG. 8, the exemplary method may begin at block 800.

In block 802, the method may include identifying, to a customer, a mobile management system that is communicatively coupled to a customer system associated with the customer via a first network and communicatively coupled to a plurality of mobile devices associated with the customer via second network. In one embodiment, the communication module 208 of the mobile management system 102 may identify, to a customer, the mobile management system 102 that is communicatively coupled to a customer system associated with the customer via a first network and communicatively coupled to a plurality of mobile devices associated with the customer via second network. The method may continue to block 804.

In block 804, the method may include storing, on the mobile management system, a plurality of template mobile applications. In one embodiment, the storage module 210 of the mobile management system 102 may store, on the mobile management system, a plurality of template mobile applications. The method may continue to block 806.

In block 806, the method may include receiving, from the customer system, modification data associated with one of the plurality of template mobile applications via the first network. In one embodiment, the order, setup, billing, and development module 202 of the mobile management system 102 may receive, from the customer system, modification data associated with one of the plurality of template mobile applications via the first network. The method may continue to block 808.

In block 808, the method may include modifying the one of the plurality of template mobile applications based on the modification data. In one embodiment, the order, setup, and development module 202 of the mobile management system 102 may modify the one of the plurality of template mobile applications based on the modification data. The method may continue to block 810.

In block 810, the method may include transmitting, to the plurality of mobile devices, the modified one of the plurality of template mobile applications via the second network. In one embodiment, the deployment module 204 of the mobile management system 102 may transmit, to the plurality of mobile devices, the modified one of the plurality of template mobile applications via the second network. The method may then end at block 812.

The mobile management service may provide the mobile devices with basic security features. For example, the basic security features may include authentication and authorization to use customer developed mobile applications, customer web services, and customer databases. In another example, the basic security features may include use of customer access protocols (e.g., lightweight directory access protocol (LDAP)) and active directory repositories. In yet another example, the basic security features may include security encryption of data (e.g., the local data store) and communication streams.

The mobile management service may also provide the mobile devices with basic device management features. For example, the basic device management features may include mobile application provisioning and management to multiple device platforms. In another example, the basic device management features may include a server-initiated “push” to proactively deliver messages and data to mobile devices.

The description above describes systems and networks that may include one or more modules, some of which are explicitly shown in the figures. As used herein, the term “module” may be understood to refer to any, or a combination, of non-transitory computer executable computing software, firmware, and hardware. It is noted that the modules are exemplary. The modules may be combined, integrated, separated, or duplicated to support various applications. Also, a function described herein as being performed at a particular module may be performed at one or more other modules or by one or more other devices instead of or in addition to the function performed at the particular module. Further, the modules may be implemented across multiple devices or other components local or remote to one another. Additionally, the modules may be moved from one device and added to another device, or may be included in multiple devices.

It is further noted that the software described herein may be tangibly embodied in one or more physical media, such as, but not limited to any, or a combination, of a compact disc (CD), a digital versatile disc (DVD), a floppy disk, a hard drive, read only memory (ROM), random access memory (RAM), and other physical media capable of storing software. Moreover, the figures illustrate various components (e.g., systems, networks) separately. The functions described as being performed at various components may be performed at other components, and the various components may be combined or separated. Other modifications also may be made.

In the preceding specification, various preferred embodiments have been described with references to the accompanying drawings. It will, however, be evident that various modifications and changes may be made thereto, and additional embodiments may be implemented, without departing from the broader scope of invention as set forth in the claims that follow. The specification and drawings are accordingly to be regarded in an illustrative rather than restrictive sense.

We claim:

1. A system, comprising:
a computing apparatus configured to identify, to a customer, a mobile management system that is communicatively coupled to a customer system associated with the customer via a first network and communicatively coupled to a plurality of mobile devices associated with the customer via a second network;
a computing apparatus configured to store, on the mobile management system, a plurality of template mobile applications;
a computing apparatus configured to receive, from the customer system, modification data associated with one of the plurality of template mobile applications via the first network;
a computing apparatus configured to modify the one of the plurality of template mobile applications based on the modification data; and
a computing apparatus configured to transmit, to the plurality of mobile devices, the modified one of the plurality of template mobile applications via the second network.

2. The system of claim 1, wherein the first network and the second network are different.

3. The system of claim 1, wherein the plurality of mobile devices are of a plurality of mobile device types.

4. The system of claim 1, wherein the modified one of the plurality of template mobile applications is executable by each of the plurality of mobile devices independent of a mobile device type associated with the mobile device.

5. The system of claim 1, wherein the plurality of mobile devices are associated with a plurality of mobile device carriers.

6. The system of claim 1, wherein the modified one of the plurality of template mobile applications is executable by each of the plurality of mobile devices independent of a mobile device carrier associated with the mobile device.

7. The system of claim 1, wherein the plurality of mobile devices are configured to operate within a plurality of countries.

8. The system of claim 1, wherein the mobile management system is configured to provide a mobile management service to the customer for a fee.

9. The system of claim 1, wherein the mobile management system is configured to provide the plurality of mobile devices with access to the customer system via the mobile management system.

10. A method, comprising:
identifying, to a customer, a mobile management system that is communicatively coupled to a customer system associated with the customer via a first network and communicatively coupled to a plurality of mobile devices associated with the customer via a second network;
storing, on the mobile management system, a plurality of template mobile applications;
receiving, from the customer system, modification data associated with one of the plurality of template mobile applications via the first network;
modifying the one of the plurality of template mobile applications based on the modification data; and
transmitting, to the plurality of mobile devices, the modified one of the plurality of template mobile applications via the second network.

11. The method of claim 10, wherein the first network and the second network are different.

12. The method of claim 10, wherein the plurality of mobile devices comprise at least one of a plurality of mobile phones, a plurality of electronic readers, and a plurality of personal digital assistants.

13. The method of claim 10, wherein the plurality of mobile devices are of a plurality of mobile device types.

14. The method of claim 10, wherein the modified one of the plurality of template mobile applications is executable by each of the plurality of mobile devices independent of a mobile device type associated with the mobile device.

15. The method of claim 10, wherein the plurality of mobile devices are associated with a plurality of mobile device carriers.

16. The method of claim 10, wherein the modified one of the plurality of template mobile applications is executable by each of the plurality of mobile devices independent of a mobile device carrier associated with the mobile device.

17. The method of claim 10, wherein the plurality of mobile devices are configured to operate within a plurality of countries.

18. The method of claim 10, wherein the mobile management system is configured to provide a mobile management service to the customer for a fee.

19. The method of claim 10, wherein the mobile management system is configured to provide the plurality of mobile devices with access to the customer system via the mobile management system.

20. A computer readable media comprising code to perform the acts of the method of claim 10.
